(19) United States
(12) Patent Application Publication
(10) Pub. No.: US 2024/0301845 A1
(43) Pub. Date: Sep. 12, 2024

(54) SYSTEMS, METHODS AND DEVICES FOR CONTROLLING IGNITION AND LAUNCHES

(71) Applicant: Gary C. ROSENFIELD, Cedar City, UT (US)

(72) Inventors: Carlin HOCHSTEDLER, Kokomo, IN (US); Gary C. ROSENFIELD, Cedar City, UT (US)

(73) Assignee: Gary C. ROSENFIELD, Cedar City, UT (US)

(21) Appl. No.: 18/428,926

(22) Filed: Jan. 31, 2024

Related U.S. Application Data
(60) Provisional application No. 63/442,385, filed on Jan. 31, 2023.

(51) Int. Cl. F02K 9/95; F23Q 7/16; F23Q 21/00

(52) U.S. Cl. CPC F02K 9/95; F23Q 7/16; F23Q 21/00

(57) ABSTRACT

Systems, methods, and devices for transmitting and controlling ignition output of a controller having a power source, a programmable interface, a wireless transmission module, and an ignition output unit are disclosed.

### BACKGROUND

Hobby rocketry is an exciting and fun way to educate and learn about physics, aerospace, electronics, and aerodynamics. Advancements and innovations in electronics, hardware, and software have increased its appeal and can be used to improve the safety of igniting rocket motors and launching rockets.

### SUMMARY

Described herein are systems, methods, and devices for controlling ignition and launch including an ignition device having one or more of: a printed circuit board, a power source connected to the printed circuit board, a power switch, an arm/disarm switch, a programming interface, a multipurpose button, a reset button, an ignition output, a buzzer, and an RGB LED.

Also disclosed is a method for connecting and controlling an ignition and launch device via a personal electronic device such as an iPhone® or iPad® including installing the application on a device, initiating the application on the personal electronic device, selecting and connecting to a launch control device via Bluetooth or other wireless connection, arming the launch control device, and providing input to request ignition.

In one aspect, the developments hereof provide a system for controlling, igniting, and providing signal between a personal electronic device and an ignition output unit.

These as well as other alternative and/or additional aspects are exemplified in several illustrated alternative and/or additional implementations and applications, some of which are shown in the figures and set forth in the claims section that follows. However, as will be understood by the ordinarily skilled artisan, the above summary and the detailed description below do not describe the entire scope of the inventions hereof and are indeed not intended to describe each illustrated embodiment or every possible implementation of the present inventions nor provide any limitation on the claims or scope of protection herein set forth below.

### BRIEF DESCRIPTION OF THE DRAWINGS

The drawings include:

FIG. 1A provides a schematic diagram of a launch control device hereof.

FIG. 1B provides an alternative of a launch control device according to or not unlike that of FIG. 1A.

FIG. 1C provides an alternative launch control device hereof.

FIG. 1D provides an alternative schematic diagram of a launch control device according to or not unlike that of FIG. 1C.

FIG. 2A provides a view of a power source.

FIG. 2B provides an alternative view of a power source.

FIG. 3A provides a view of an arrangement of launch control device and battery case.

FIG. 3B provides an alternative view of a launch control device and battery case.

FIG. 4A provides a view of an exemplary case or enclosure for a launch control device.

FIG. 4B provides an alternative view of an exemplary case or enclosure for a launch control device.

FIG. 5A provides a view of the battery case inserted in the enclosure.

FIG. 5B provides an alternative view of the battery case inserted in the enclosure or case.

FIGS. 6A, 6B, 6C, 6D, 6E, 6F, 6G, 6H, 6I, and 6J provide images and/or screenshots of the graphical user interface of the application on a personal electronic device at different stages of the application.

FIGS. 7A and 7B provide a flow charts of uses according hereto.

FIGS. 8, 8B, and 8C provide alternative flow charts of uses according hereto.

FIG. 9 provides a schematic block diagram of an example of a personal electronic device used in the system and methods hereof.

FIGS. 10A and 10B provides a schematic diagram of a system and method hereof.

### DETAILED DESCRIPTION

While the inventions hereof are amenable to various modifications and alternative forms, specifics hereof have been shown herein by way of non-limitative examples in the drawings and the following description. It should be understood, however, that the intention is not to limit the inventions to the particular embodiments described. The intention is to cover all modifications, equivalents, and alternatives falling within the spirit and scope of the inventions whether described here or otherwise being sufficiently appreciable as included herewithin even if beyond the literal words or figures hereof.

In general, included here are systems, methods, devices, and technology that provide for wireless control of ignition devices for rocket motors. The systems, methods, and devices enable a user to remotely and wirelessly provide communication to the ignition control to provide instructions to ignition output to launch. The device and system may have several operating states including: idle, countdown, ignition, and error/short circuit. These are described in more detail below.

Improvements and new developments may yet be desired for rocket ignition control devices, systems, and methods that provide for increased safety and wireless control of the ignition device. Thus, alternatives for rocket enthusiasts may then include systems, methods, and devices for connecting and configuring the controller to a connect to personal electronic device, arming the controller to control the ignition, and providing a request to the controller to ignite the connected rocket motor. Thus, described herein are several systems, methods, and devices for controlling and providing ignition information to launch a hobby rocket. A number of alternative implementations and applications are summarized and/or exemplified herein below and throughout this specification.

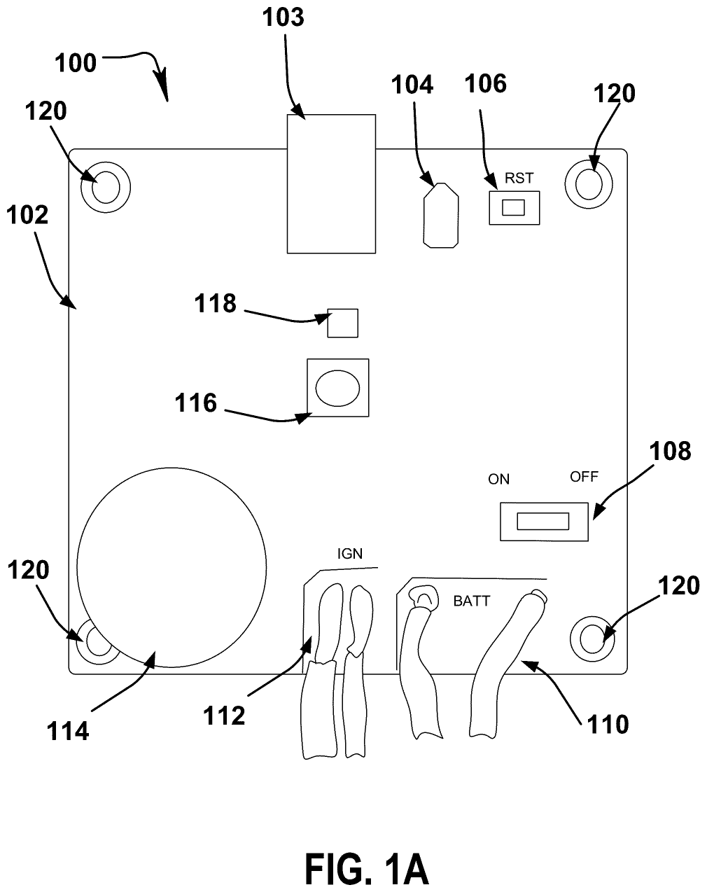

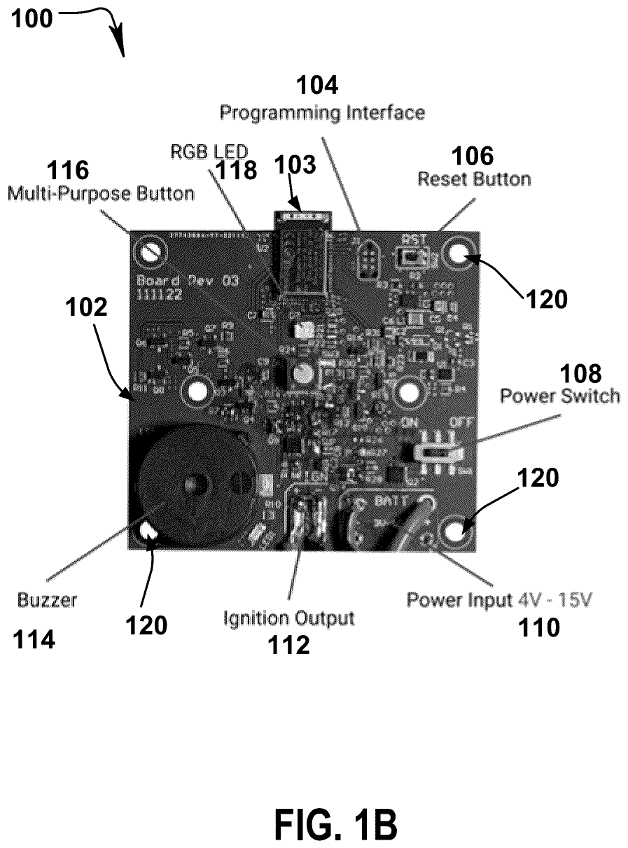

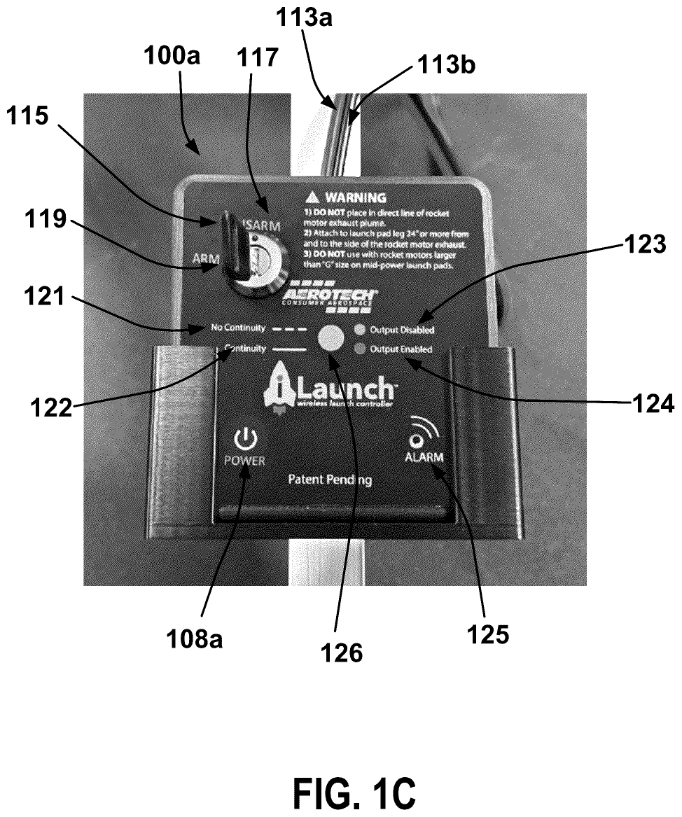

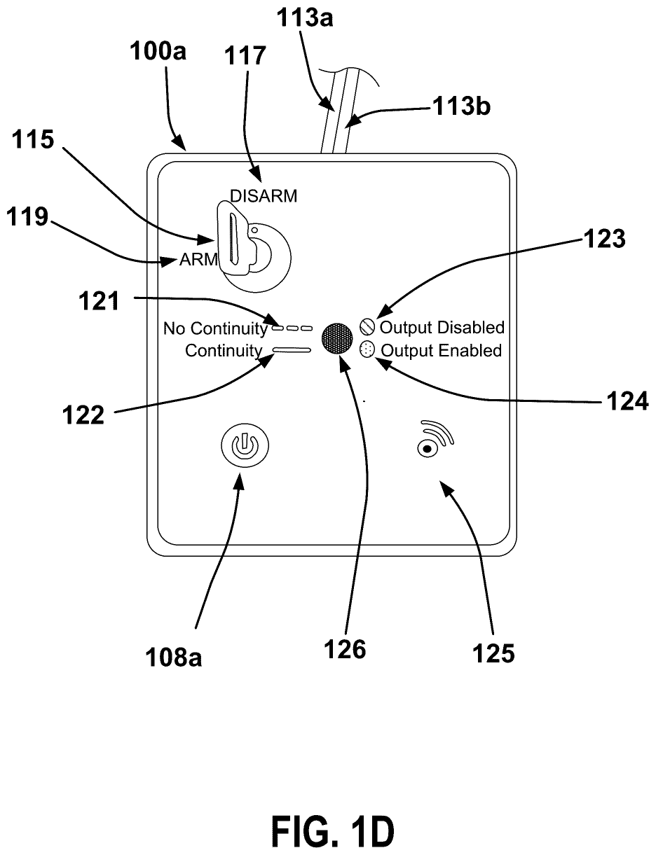

As shown in FIG. 1A, a device, or launch control unit, or controller 100 in many cases includes a printed circuit board 102, a programming interface 104, a reset button 106, a power switch 108, a power input 110, an ignition output 112, a buzzer 114, a multi-purpose button 116, and a RGB LED 118. Mounting holes 120 may provide a way to secure the printed circuit board inside an enclosure or case described in more detail below. The device may also have a Bluetooth® or other wireless communication module 103, or wireless chip that allows the device to connect to a personal electronic device such as an iPhone® or iPad®, or Android® based device. A personal electronic device may include any electronic device capable of storing computer based instructions in a memory, processing computer implemented instructions on a processor, and displaying information on a screen or monitor. Thus, personal electronic devices may include mobiles phones, tablets, laptop computers, and in some instances even desktop computers. In alternative implementations, the personal electronic device may be a dedicated hardware controller. The dedicated hardware controller, or control fob (not pictured), may have one or more mechanical buttons that allow for control of signals provided to the launch control unit 100.

FIG. 1B provides an alternative view of a device, or launch control unit, or controller 100 in many cases includes a printed circuit board 102, a programming interface 104, a reset button 106, a power switch 108, a power input 110, an ignition output 112, a buzzer 114, a multi-purpose button 116, and a RGB LED 118. Mounting holes 120 may provide a way to secure the printed circuit board inside an enclosure or case described in more detail below. The device may also have a Bluetooth® module 103, or other wireless chip that allows the device to connect to a personal electronic device such as but not limited to an iPhone® or iPad®, or Android® based device.

FIGS. 1C and 1D shown is an alternative device, or launch control unit, or controller 100a which in many cases includes a power switch 108a, ignition output leads 113a, 113b, and an arm/disarm key switch 115. The arm/disarm switch 115 has an arm position 119 and a disarm position 117. Also shown are several optional indicators, here including lights (e.g., could be LEDs) for either continuity 122, or no continuity 121, and alternatives for output enabled 124 or disabled 123. Also shown are the alarm buzzer 125 and a general power indicator 126. The device may also have a Bluetooth® or other wireless communication system, or wireless chip that allows the device to connect to a personal electronic device such as an iPhone® or iPad®, or Android® based device. A personal electronic device may include any electronic device capable of storing computer based instructions in a memory, processing computer implemented instructions on a processor, and displaying information on a screen or monitor. Thus, personal electronic devices may include mobiles phones, tablets, laptop computers, and in some instances even desktop computers. In alternative implementations, the personal electronic device may be a dedicated hardware controller. The dedicated hardware controller, or control fob (not pictured), may have one or more mechanical buttons that allow for control of signals provided to the launch control unit 100a.

In FIGS. 1C and 1D an alternative option is to have a safety interlock key or slide or other physical arming or arm/disarm switch 115 in/on the controller 100a. In such an option this would be in addition to the power switch 108a and operate to merely indicate whether the actual power to the igniter is activated or live, or alternatively off or not active. The power switch would thus be merely to activate the circuitry for connection to the wireless igniter and/or additionally set-up or check other Idle state operations and/or connections. An arm/disarm switch 115 may be used in addition to or instead of the other wireless “ARM” or “DISARM” features as described hereinbelow. Distinctively an arm/disarm switch 115 would physically connect or disconnect or physically “switch” to either allow or disallow ignition current/voltage to the igniter. When switched to “DISARM” position, no electrical connection is made or capable to the igniter leads, but, when contrarily switched to “ARM”, then, power is physically and electrically available to the igniter leads upon other control commands as described herein. Note, the multi-purpose button may have been used for power and, in some implementations arming and/or disarming; now, in the implementations of FIGS. 1C and/or 1D, it or a button not unlike it may instead provide merely the function as the power button; here button 108a. It may thus be a toggle, whether push button or alternative-press once to turn on and press once to turn off. A further alternative and/or additional feature may be an auto shutoff; if there is no connection for some set or settable period, as for example, 2 hours, the device will automatically turn off to conserve the batteries. A non-limiting exemplar key switch may be a Gebildet On/Off Metal Key Lock Switch or Prewired Key Switch or Lock Maintained Latching Key Switch. Other brands and/or physical switches (not shown) could be used, such as without limitation to this listing or functionality or brand, a slide switch, a push-button switch a toggle switch, rocker toggle, rotatable or rotary 2-position selector switch, or others.

In some instances, the controller 100/100a may have one or more antennas that are connected to and electronically communicative with the printed circuit board that may be used to extend the range of the controller 100/100a, if necessary or desirable. In some cases, these antennas may be extendable and adjustable, that is, the one or more antennas may be connected, disposed, and configured in many different positions and angles in relation to the controller in order to improve the reception and range of the controller.

The controller 100/100a may have several states that it may be in at any given point in time. If the controller is turned ON, via the ON/OFF switch 108, the controller 100/100a may be in one of the following states: (1) Idle, (2) Countdown, (3) Ignition, or (4) Short-Circuit. If used or implemented also, the arm/disarm switch 115 can also be used in setting or determining in which of one or more states the controller 100/100a may be disposed. For example such an arm/disarm switch 115 can be used to toggle from the “(1) Idle” state to the “(2) Countdown” state and/or the “(3) Ignition” state.

In the Idle state, the controller is waiting for commands from the mobile app installed of a user's electronic device. If an ignitor is detected, the LED 118 will illuminate green indicating continuity. It may be that initial electronic communications such as this may be active during the Idle state before the arm/disarm switch may be activated to enable physical power connection to the igniter leads.

In the Countdown state, the buzzer is activated every second in sync with the app. This provides feedback to anyone nearby that a launch is in progress. The countdown is completely managed by the application of a user's electronic device, and can be aborted at nearly any point up until the launch signal has been sent. In one implementation, if a disconnection occurs during a countdown, the launch will be automatically aborted. Upon completion of the countdown state, the controller is put in the ignition state.

In the Ignition state, the ignition output is enabled. The buzzer is connected directly to the output so anytime it is enabled, the buzzer will be activated. During ignition, the output current and supply voltage are monitored continuously. The output is disabled as soon as less than 100 mA is detected. If the battery voltage drops too low, or the output current is too high, the controller is put in the short-circuit state.

In the Short-circuit state, the LED will flash red. The controller may be returned to the idle state by the app, or by disconnecting the ignitor/removing the short. The app returns the controller to the idle state at the beginning of every countdown.

The developments hereof also include one or more safety elements that may be communicated and displayed to a user connected via their personal electronic device, or that may cause the buzzer or RGB LED to provide a simple indication of an issue, either as one or both an audible or visual indication, that an issue needs to be checked or resolved with the controller 100. These developments may include one or more of: (1) over-current protection, (2) continuity detection, and/or (3) minimum voltage detection.

The printed circuit board 102 as in FIG. 1, may have an over-current protection circuit to support high-current power sources. The controller is designed and supported to use both alkaline and lithium AA or 9V batteries; however, different battery configurations are possible. Thus, the over-current protection circuit is provided to one or both provide visual or audible alert at the controller if an issue is detected with the current of the device, either by flashing the RGB LED located on the printed circuit board, or by intermittently activating and/or buzzing the buzzer. In an alternative development, an error message and/or audible alert may be communicated to a user's personal electronic device that the over-current protection circuit has detected an issue that needs resolution before a user can safely and reliably utilize the controller.

In an alternative development, an error message and/or audible alert may be communicated to a user's personal electronic device that the continuity detection circuit has detected an issue that needs resolution before a user can safely and reliably utilize the controller.

Furthermore, the printed circuit board 102 as in FIG. 1, may have a minimum voltage sensor. This sensor may be integrated to ensure that the voltage from the power source is of sufficient voltage to cause ignition at the proper speed. Thus, the buzzer may provide an audible signal (and/or LED may flash) if and when the source voltage is detected to be less than a certain pre-defined minimum amount. In an alternative development, an error message and/or audible alert may be communicated to a user's personal electronic device that the minimum voltage sensor has detected an issue that needs resolution before a user can safely and reliably utilize the controller.

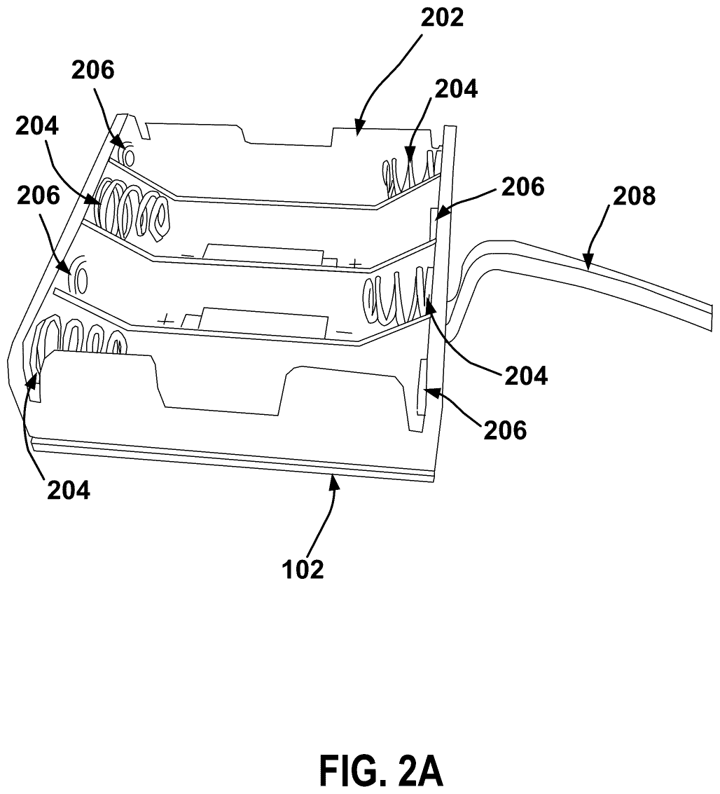

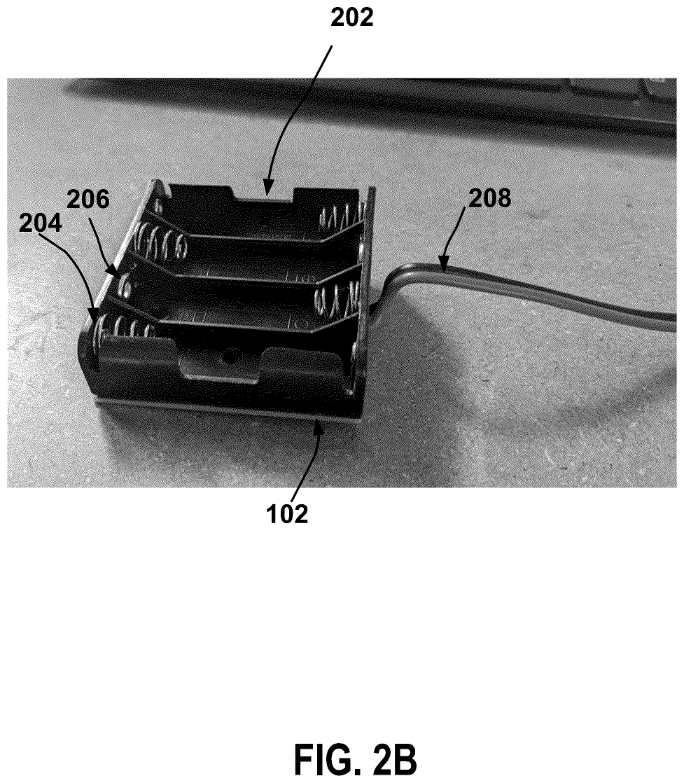

FIG. 2A provides a view of the battery holder 202 which in this view is mounted on the reverse side of the printed circuit board 102. The battery holder 202 may have one or more spring contacts 204, and one or more contacts 206 for providing power to the device via the power cables 208.

FIG. 2B provides an alternative view of the battery holder 202 (in some instances battery case, or casing) which in this view is mounted on the reverse side of the printed circuit board 102. The battery holder 202 may have one or more spring contacts 204, and one or more contacts 206 for providing power to the device via the power cables 208.

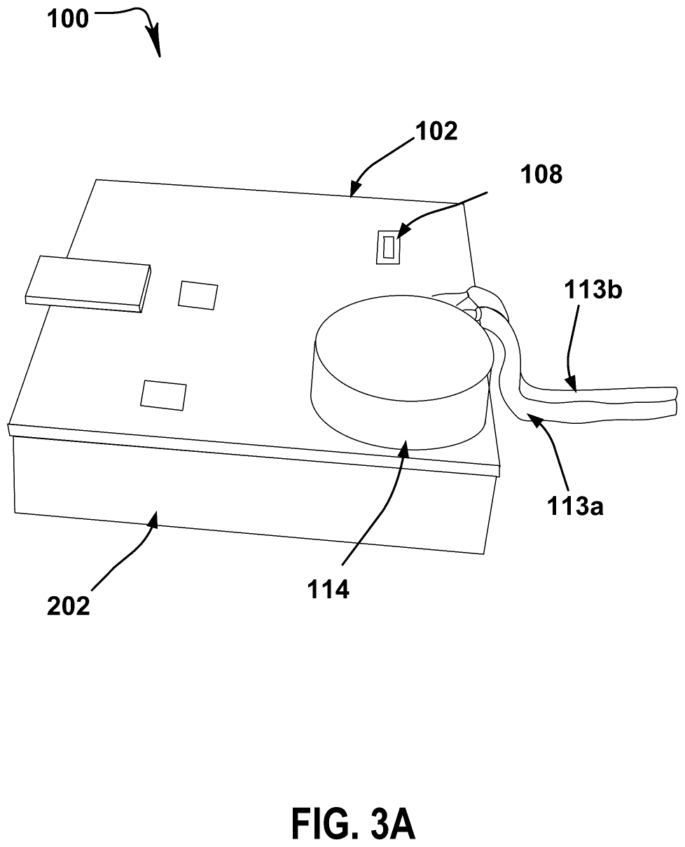

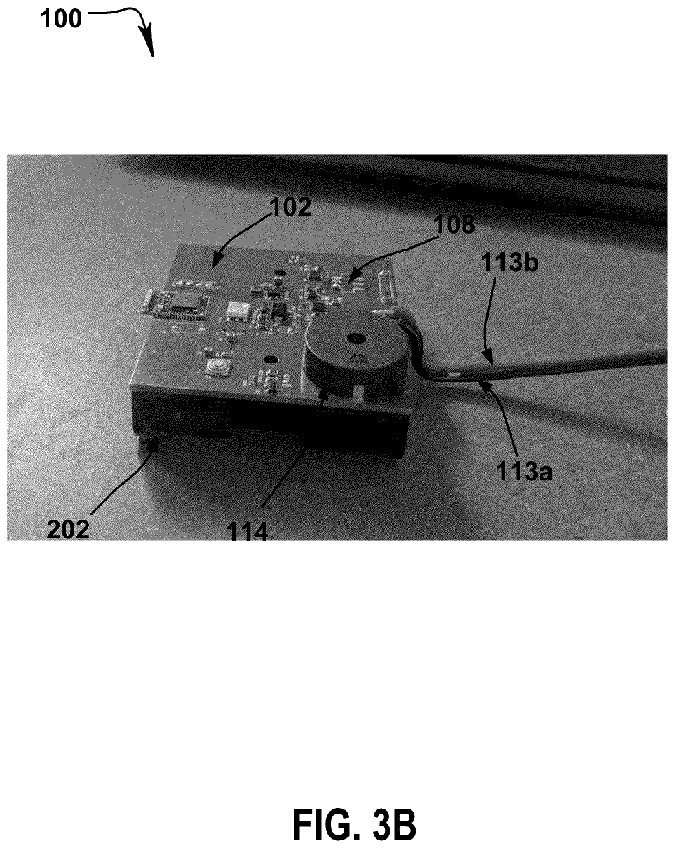

FIG. 3A provides a view of a device, or launch control unit, or controller 100/100a, having a printed circuit board 102 mounted to the battery case 202. The launch control unit has a power switch 108, a buzzer 114, and ignition leads 113a, 113b.

FIG. 3B provides an alternative view of a device, or launch control unit, or controller 100/100a, having a printed circuit board 102 mounted to the battery case 202. The launch control unit has a power switch 108, a buzzer 114, and ignition leads 113a, 113b.

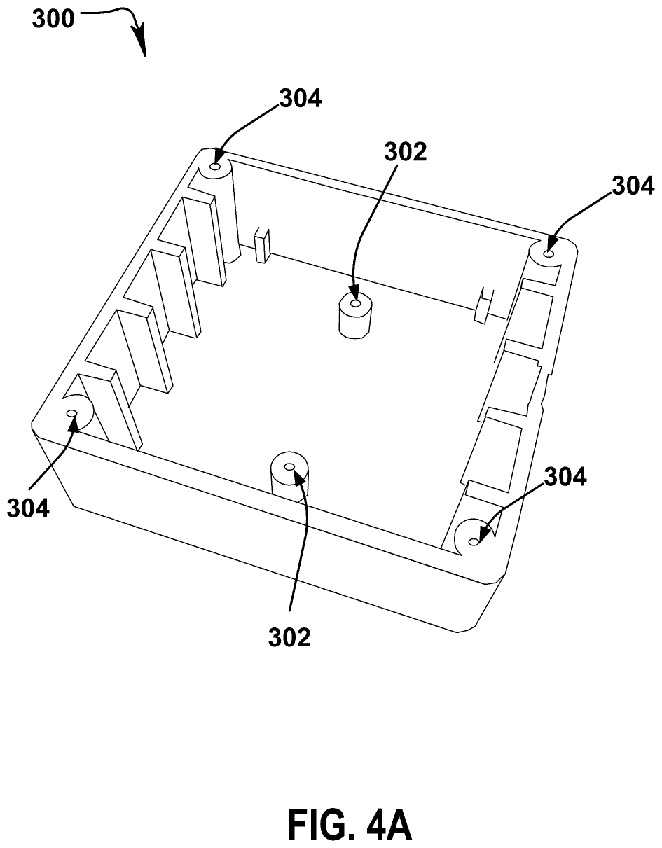

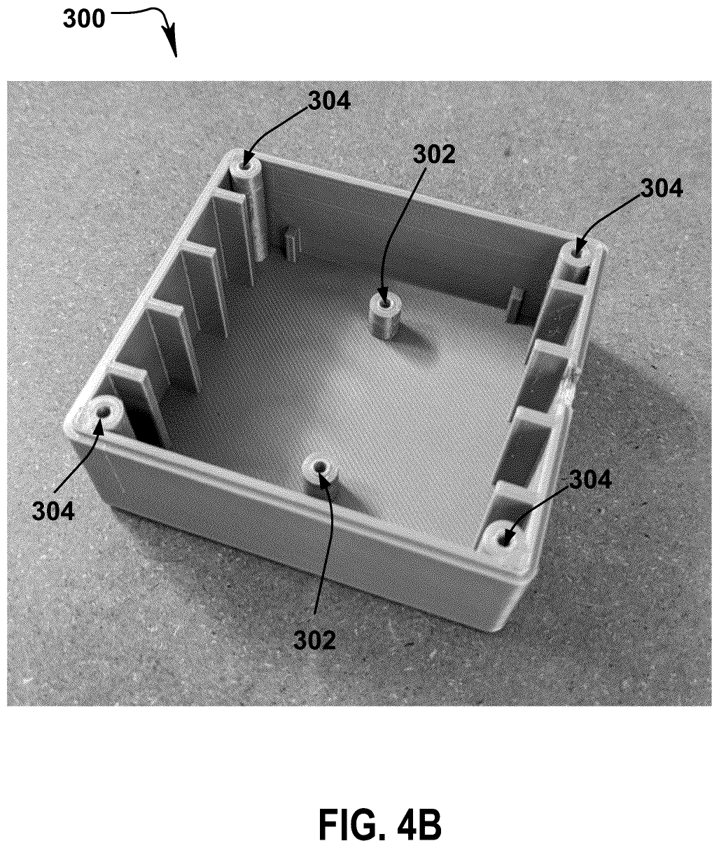

FIG. 4A provides a view of an enclosure or casing 300 for the device or controller. The enclosure 300 may have one or more mounting holes 302 to attach and secure a cover for the enclosure, and may have one or more mounting holes 304 to secure the controller inside the enclosure via screws, not pictured. The enclosure may be constructed of rigid plastic or ABS material. The enclosure may be formed through thermo-molding or 3D-printed.

FIG. 4B provides an alternative view of an enclosure or casing 300 for the device or controller. The enclosure 300 may have one or more mounting holes 302 to attach and secure a cover for the enclosure, and may have one or more mounting holes 304 to secure the controller inside the enclosure via screws, not pictured. The enclosure may be constructed of rigid plastic or ABS material. The enclosure may be formed through thermo-molding or 3D-printed.

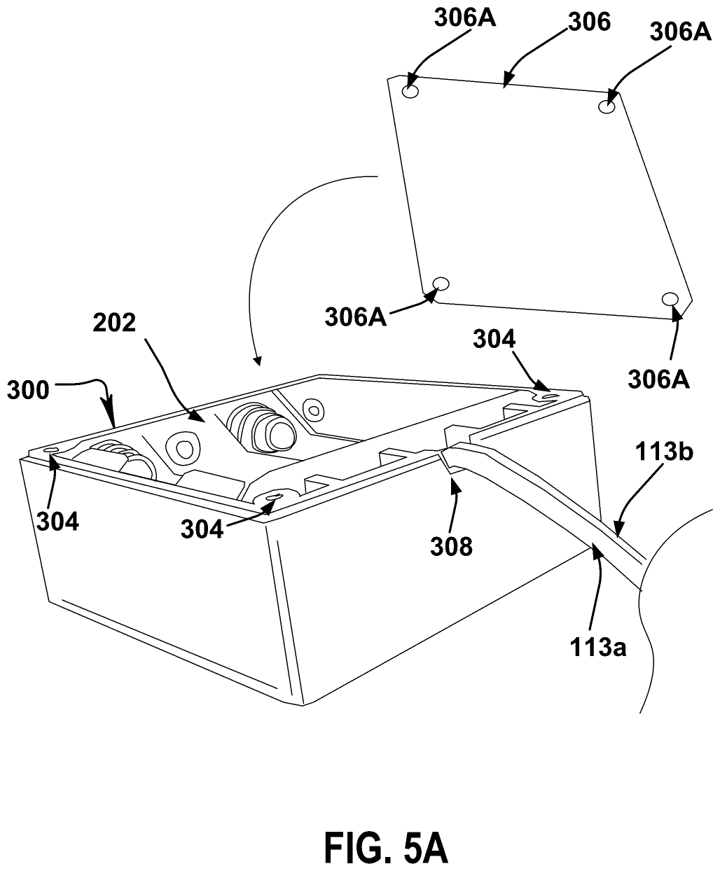

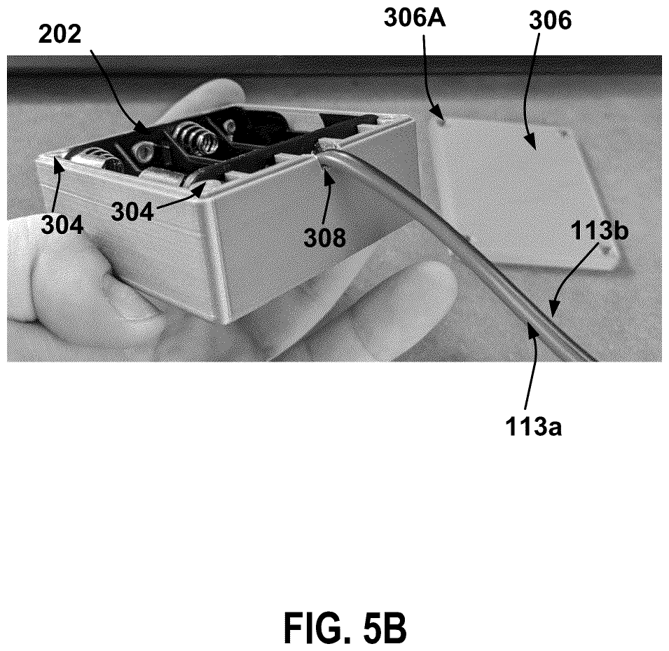

FIG. 5A provides a view of the battery case 202 and controller (not pictured) inserted inside the enclosure 300. The enclosure cover 306 is connected and secured to the enclosure 300 via aligning connection holes 306A with mounting holes 304 of the enclosure. The enclosure 300 provides protection of the both the battery case and thus power source, and the printed circuit board from moisture, dust, and debris. The enclosure 300 provides a passage 308 for the ignition cables/leads 113a, 113b to connect to the printed circuit board enclosed and encased in the enclosure, yet the leads are able to flexibly extend through the casing to be connected to ignition leads of a rocket motor (not pictured).

FIG. 5B provides another view of the battery case 202 and controller (not pictured) inserted inside the enclosure 300. The enclosure cover 306 is connected and secured to the enclosure 300 via aligning connection holes 306A with mounting holes 304 of the enclosure. The enclosure 300 provides protection of the both the battery case and thus power source, and the printed circuit board from moisture, dust, and debris. The enclosure 300 provides a passage 308 for the ignition cables/leads 113a, 113b to connect to the printed circuit board enclosed and encased in the enclosure, yet the leads are able to flexibly extend through the casing to be connected to ignition leads of a rocket motor (not pictured).

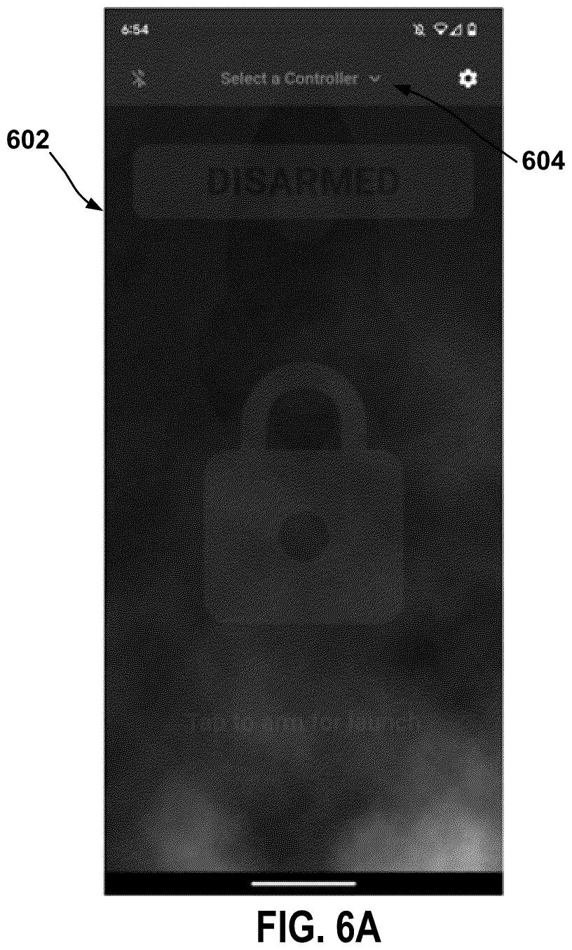

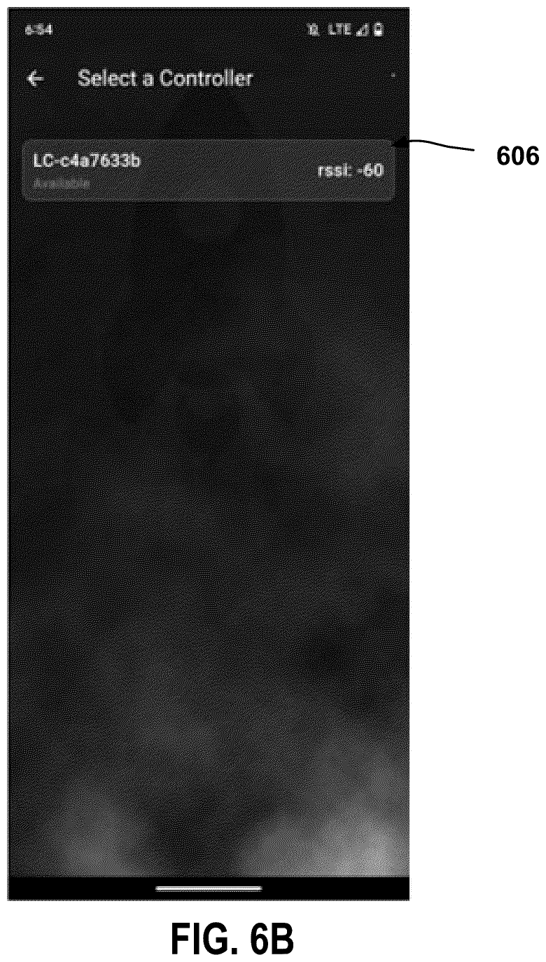

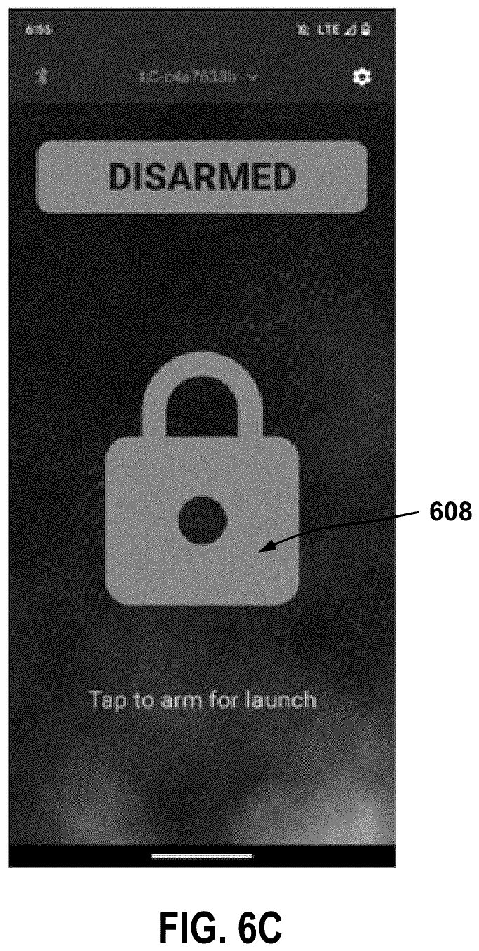

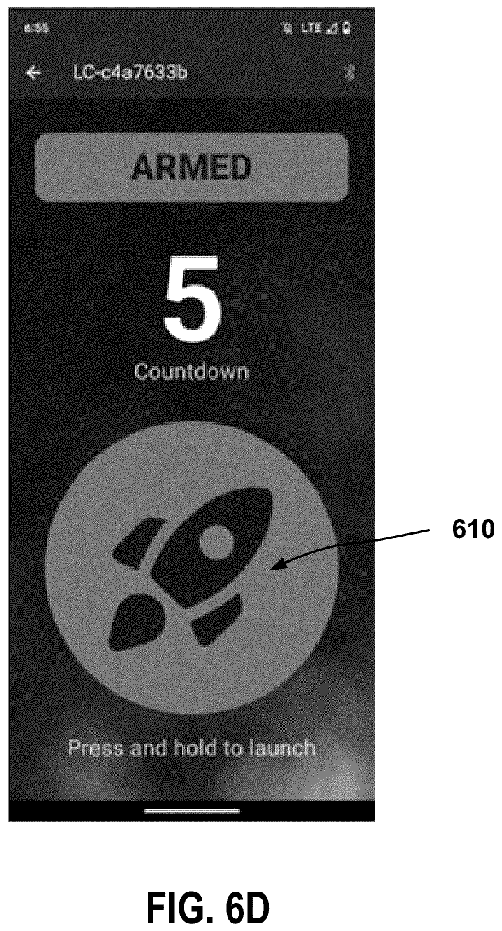

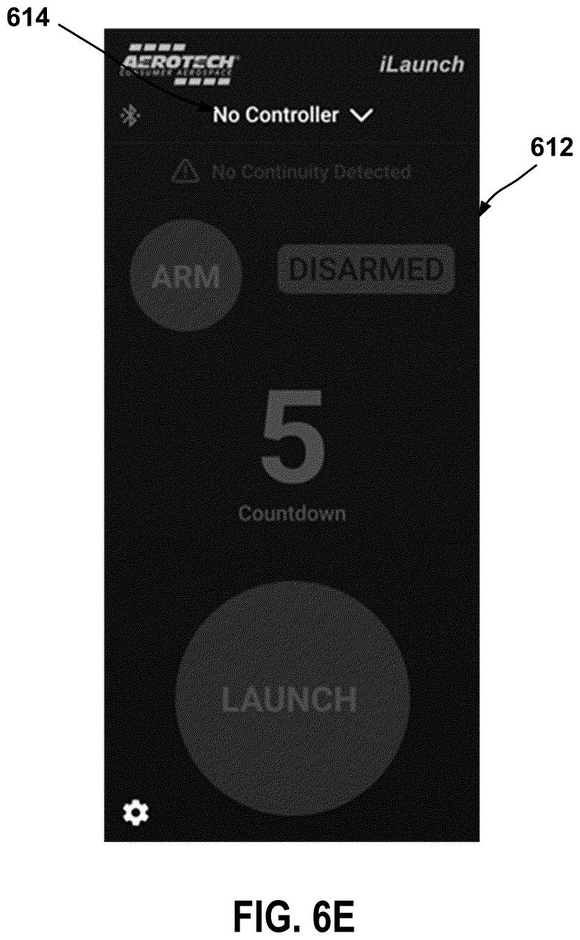

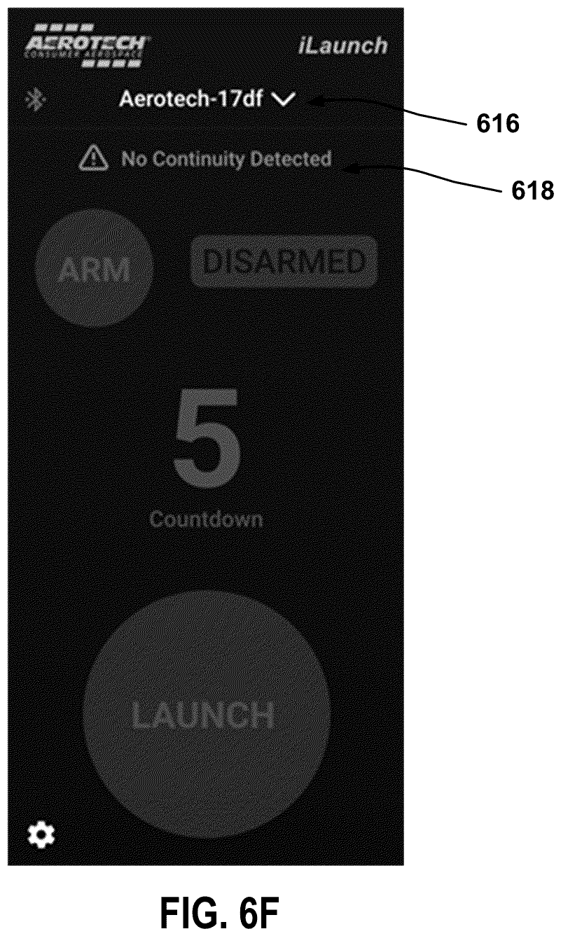

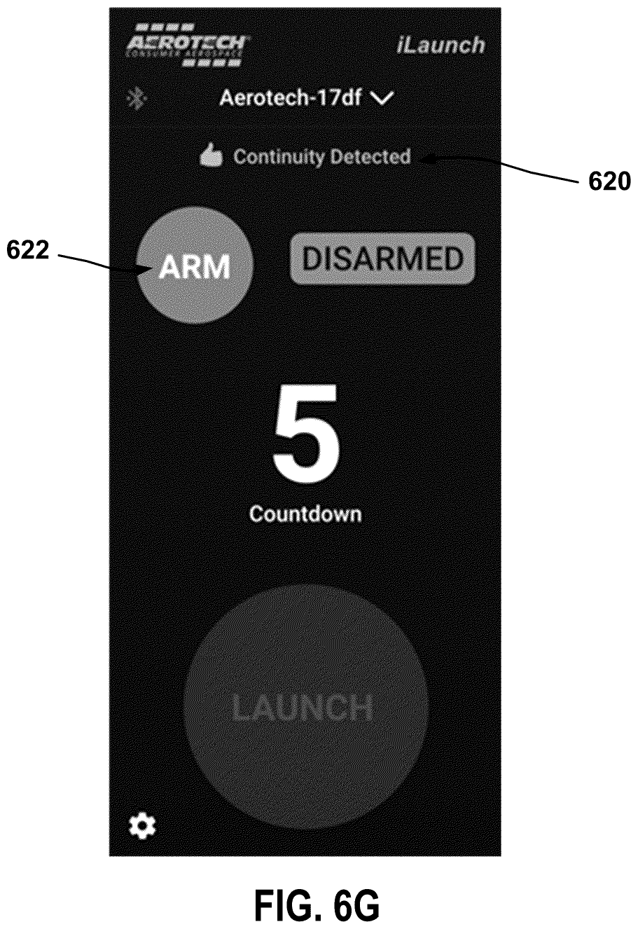

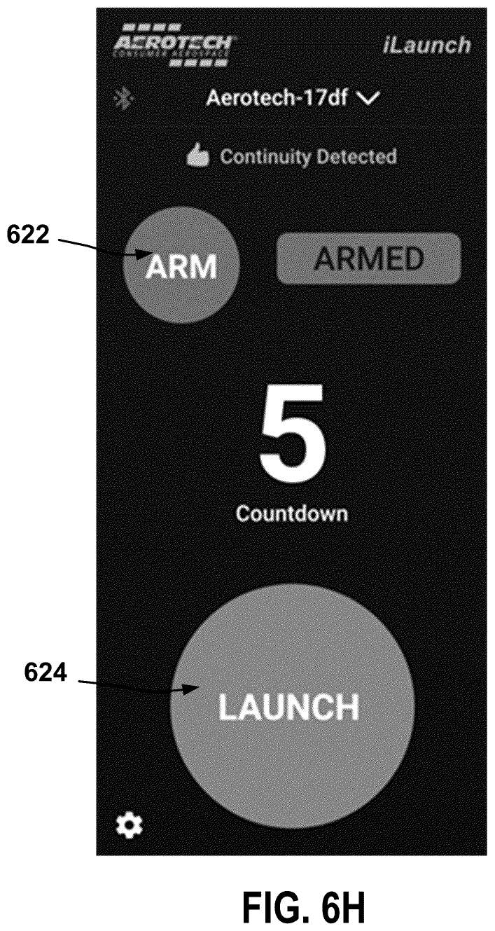

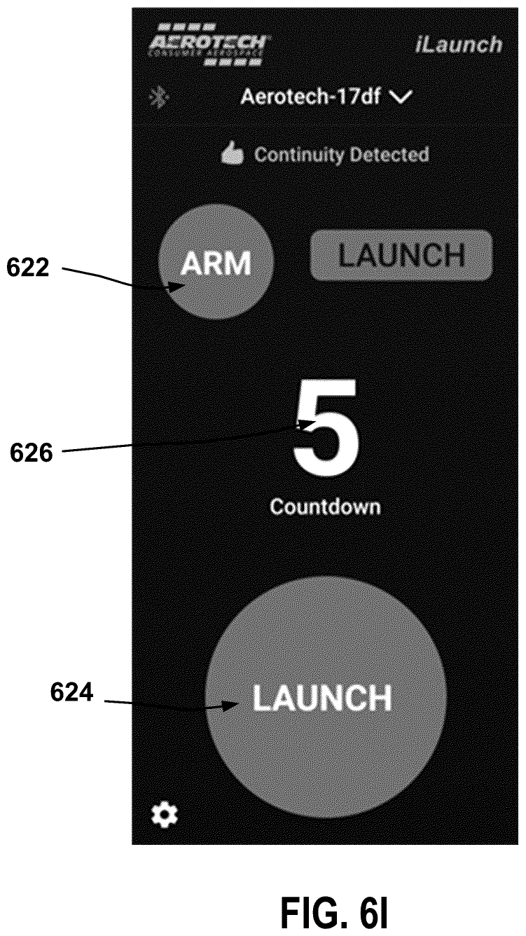

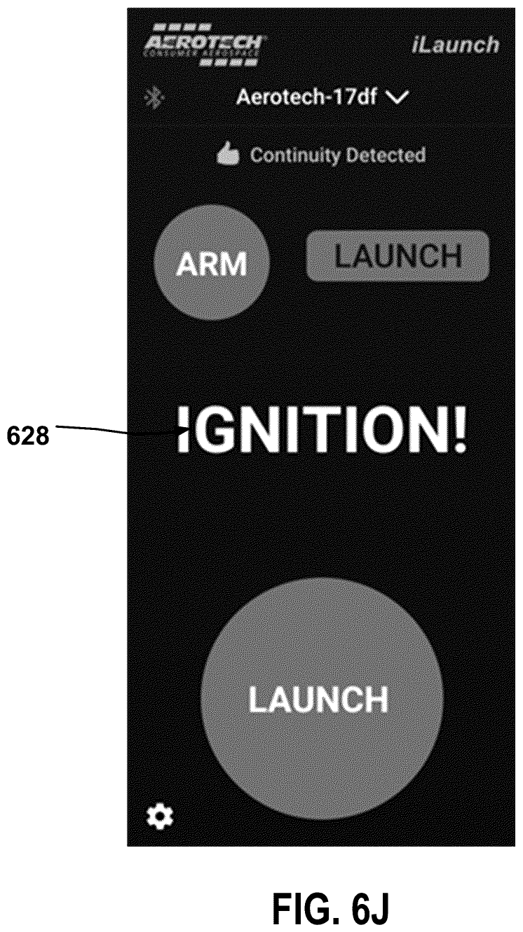

FIGS. 6A, 6B, 6C, and 6D provide screenshots of the user interface of the app on a user's personal electronic device such as a cellular phone or tablet. When the app is initiated, a disarmed screen 602 is presented without a controller selected, as shown in FIG. 6A. If the dropdown, “Select a Controller” 604 is selected, nearby, in-range and powered on controllers will be displayed. An example of the “Select a Controller” listing is shown in the screenshot in FIG. 6B. A controller 606 can be connected to by the app, by selecting in from the list of available controllers.

In some instances, on first connection and initiation of the app, the user may be asked to accept Bluetooth® or other wireless communications and location permissions. A user may need to enable location permissions in order to allow the app to connect and control the controller.

Once the controller is connected to the app, the user interface (UI) will show the “disarmed” badge as in FIG. 6C. A user may arm the controller for ignition and launch by tapping the large “Lock” icon 608. This may be in addition to or in lieu of use of an arm/disarm switch 115, the arm/disarm switch 115 being on the controller 100/100a and activated there.

To start the ignition countdown, a user can press and hold the “launch button” 610 as shown in FIG. 6D. The phone or personal electronic device will vibrate, and the buzzer located on the device will activate in sync with every second of the countdown. After the countdown is complete, the ignition command/request will be sent to the controller which activates the ignition output.

FIGS. 6E, 6F, 6G, 6H, 6I, and 6J provide screenshots of an alternative embodiment of the user interface of the application on a user's personal electronic device.

When the app is initiated, a disarmed screen 612 is presented without a controller selected, as shown in FIG. 6E. If the dropdown, “Select a Controller” 614 is selected, nearby, in-range and powered on controllers will be displayed. An example of the “Select a Controller” listing is shown in the screenshot in FIG. 6F. A controller 616 can be connected to by the app, by selecting in from the list of available controllers.

FIG. 6F demonstrates that the controller may be detected, but continuity or discontinuity is detected and an error message 618, such as, “No Continuity Detected” may be displayed in the user interface. This message indicates an ignitor is not present or not connected properly. All launch functionality is disabled when continuity is not detected.

FIG. 6G provides a screenshot demonstrating that continuity is detected and thus displayed as a message 620, such as “Continuity Detected.” This indicates and confirms that an ignitor is present and properly connected. As a result, an ARM button 622 is enabled. The user can press and hold the ARM button to arm the controller. In an alternative or in addition to such a procedure, though not in FIG. 6G, the arm/disarm switch 115 may be used on the controller 100/100a to arm or disarm the physical ignition output electrical connection to, i.e. to either connect or switch off power to, the igniter leads from the controller.

FIG. 6H shows that for the wireless ARMing procedure, pressing the ARM button arms the controller and also provides visual and audio indication to the user that the controller has been armed. For example, the button 622 may be programmed to change color and the cause the either or both of the controller and the personal electronic device to emit a continuous tone indicating that the controller is armed. If the ARM button is released at any time, the controller is disarmed. The arming of the controller enables the LAUNCH button 624. A user must press and hold the LAUNCH button 624 to begin the countdown/launch sequence.

FIG. 6I shows that the ARM button 622 and LAUNCH button 624 are pressed simultaneously. This initiates the countdown/launch sequence 626. The controller and/or the personal electronic device will emit short tones in sync with the countdown decrement. The user interface may show the countdown clock 626 to the user. If either the ARM button 622 or the LAUNCH button 624 are released at any time, the application returns to the disarmed state and the user must go through the launch sequence again.

FIG. 6J provides a screenshot that demonstrates that the countdown has completed and the controller has put power to the ignitor. A message 628, such as “IGNITION!” may be displayed for the user. When either the ARM button 622 or the LAUNCH button 624 are released, the application will return to the disarmed state, as shown in FIG. 6G.

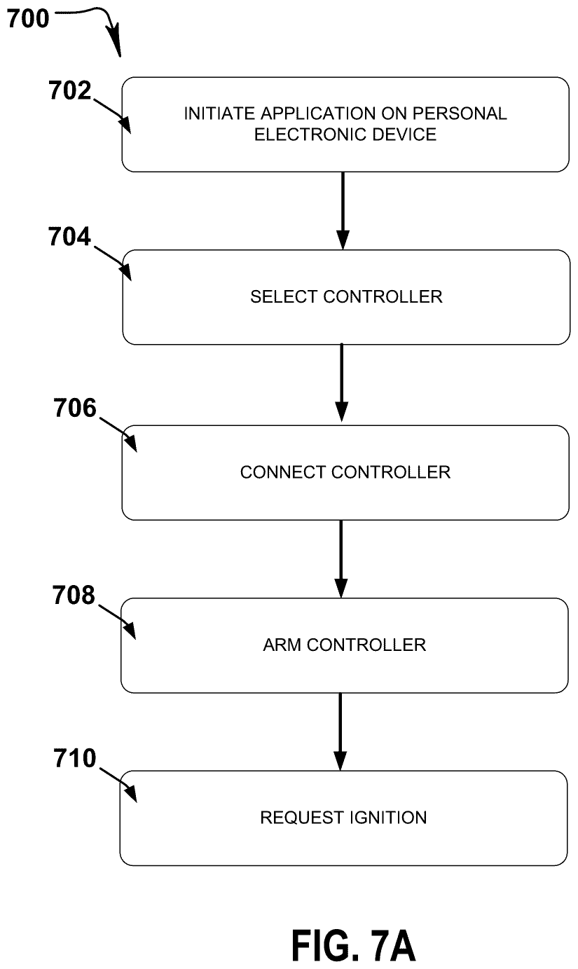

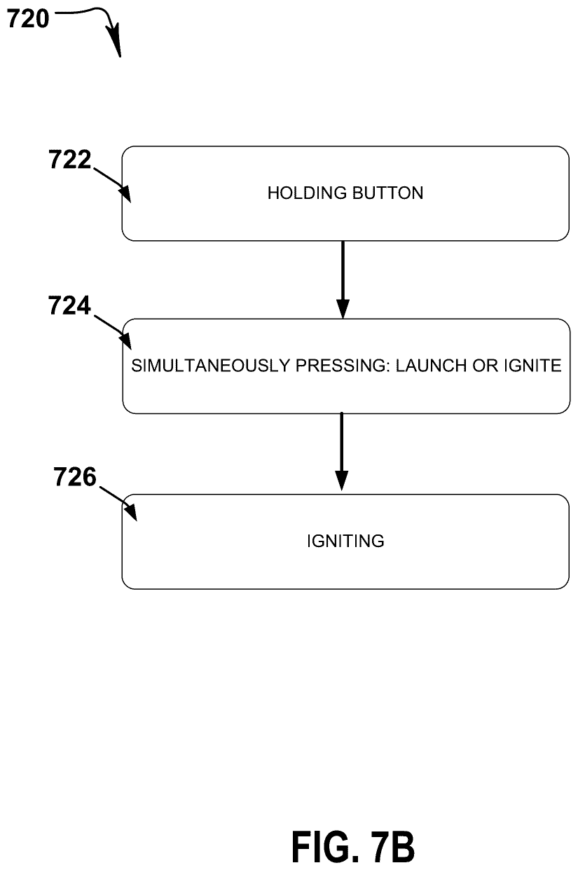

Some summary methodologies may now be understood with relation to FIG. 7A, though others may be understood through and as parts of the remainder of the disclosure hereof. A flow chart 700 as in FIG. 7A may demonstrate one alternative, where an initial action 702 may be to initiate the application on personal electronic device. After initiating the application, the user will navigate using the user interface on the personal electronic device to select 704 and/or pair the controller. The user selecting the controller 704 facilitates connecting the controller 706 and thus provides a wireless communication link between the controller and the personal electronic device. Next, the user may utilize the user interface and provide input to arm the controller 708 which communicates to the controller the necessary instructions to prepare the controller for additional commands related to ignition and ignition output. Next, the user may again provide input to the user interface to request ignition 710. In one implementation, by providing the request for ignition, the user may start the ignition countdown by pressing and holding a red launch/rocket icon (or button) located in the UI. In response to receiving this command, the phone/personal electronic device may vibrate and the controller buzzer will activate in sync with every second of the countdown. After the countdown is complete, the ignition command will be sent to the controller activating the ignition output.

Additional summary methodologies may be understood with relation to FIG. 7B. A flow chart 720 as in FIG. 7B may demonstrate one alternative. Thus one alternative implementation may include holding or depressing a button 722, such as the ARM button, on a personal electronic device for a period of time, such as, for example, 1 second, 2 seconds, 3 seconds, 4 seconds, or 5 seconds, and then simultaneously pressing or depressing a button 724, such as a LAUNCH button or IGNITE button. In some implementations, the pressing of the combination of buttons in a particular order may be used to provide signal to the controller to cause the controller to provide ignition output.

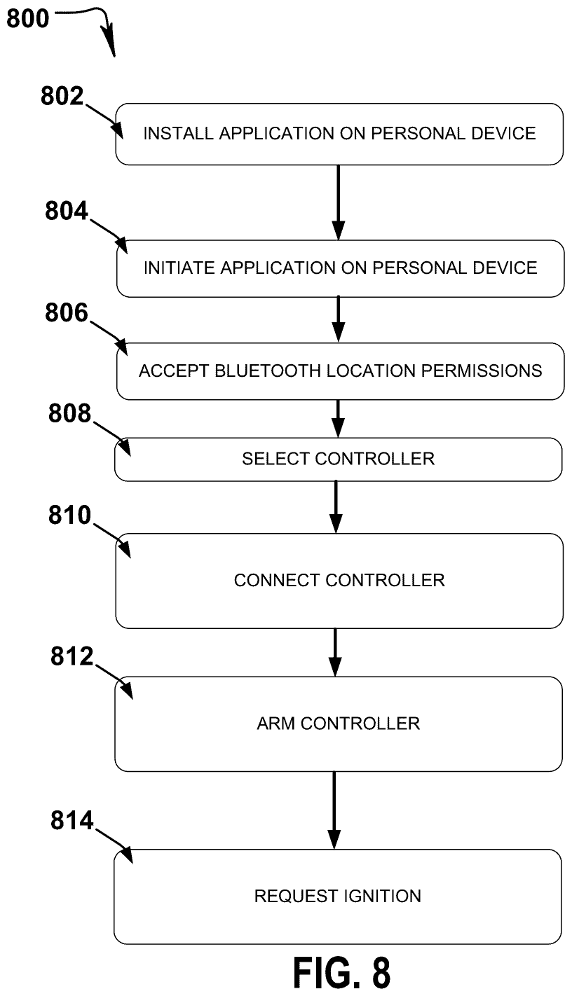

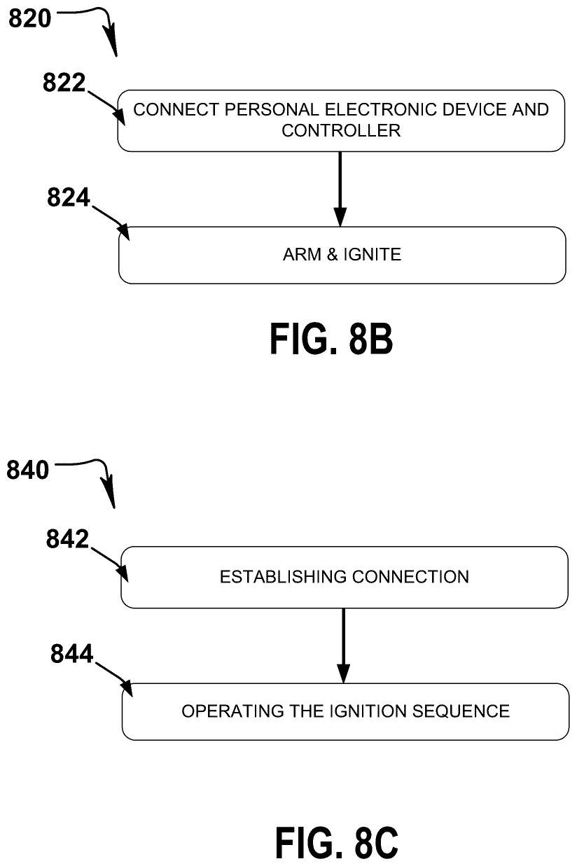

An alternative summary methodology is shown in FIG. 8 by way of flowchart 800. Initially, the user may download and install the application on their personal electronic device 802. Next, the user may initiate the application on their personal electronic device 804. Next, the user may need to accept and configure Bluetooth® or other wireless location permissions 806 to allow the application to communicate with the controller. Next, the user may navigate the user interface on their device to select a controller 808. If the controller is in communication range and powered on, the personal electronic device will connect 810 to the selected controller and be ready for input from the user via their personal electronic device. Next, the user may provide input to arm the controller 812 which provides communication to the controller of the necessary instructions to prepare the controller for additional commends related to receiving instructions for ignition and ignition output. Next, the user may again provide input via the user interface to request ignition 814 countdown by, for example, pressing and holding a red launch button on their touchscreen personal electronic device (or phone). The phone will vibrate and the controller buzzer will activate in sync with every second of the countdown. After, the countdown is complete, the ignition command will be sent to the controller activating the ignition output. As a prerequisite, the user would ensure that their device has Bluetooth® or other wireless connection protocol turned on and enabled for communication with the controller 100/100a of FIG. 1 (sub-part FIGS. 1A, 1B, 1C, 1D, inter alia), et al. Also, prior to this action, the use would have turned on the controller using the power button located on the controller. Thus, there may be alternative and additional actions according to the methodologies described herein.

An alternative summary methodology is provided in FIG. 8B. Flowchart 820 provides an alternative implementation for connecting a personal device and controller 822 and then using the personal electronic device to arm and ignite 824 the controller.

Another alternative summary methodology is provided in FIG. 8C. Flowchart 840 provides an alternative implementation for establishing a connection 842 between a personal electronic device and a controller. Once the connection has been established, the connection may be used for operating the ignition sequence 844.

During the process and method of controlling and operating the device and system hereof, numerous checks and precautions may be implemented in the controller and the application to prevent accidental ignition. Thus, numerous measures in the software and hardware of the controller may exist so that if any hardware, software, or communication error occurs, the system, device, and method will fail safely, so as to prevent accidental ignition.

An exemplary computer system or computing resources which may be associated with or contained by the personal electronic device 900 and used herewith will now be described, though it should be noted that many alternatives in computing systems and resources may be available and operable within the reasonably foreseeable scope hereof so that the following is intended in no way to be limiting of the myriad possible computational alternatives properly intended within both the spirit and scope hereof.

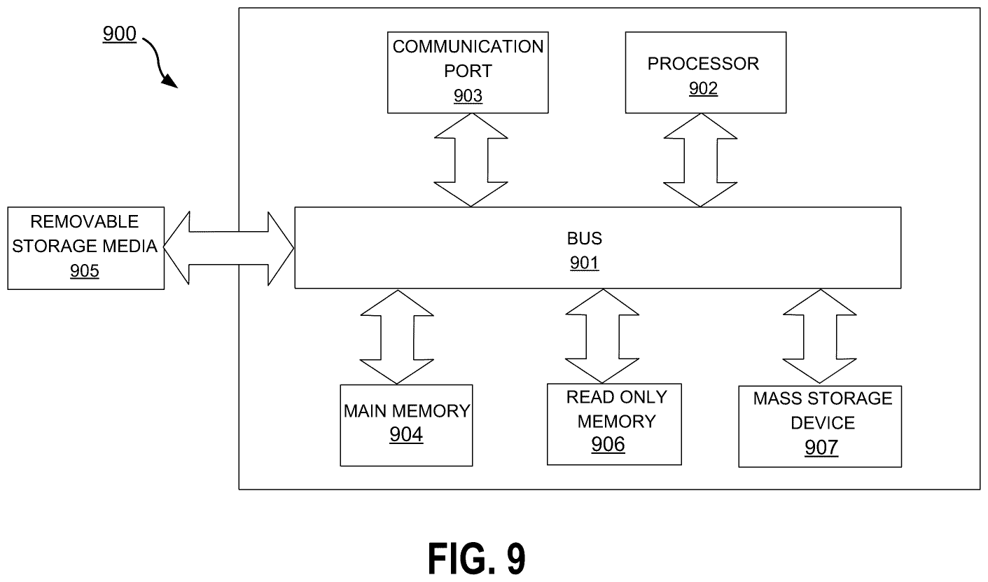

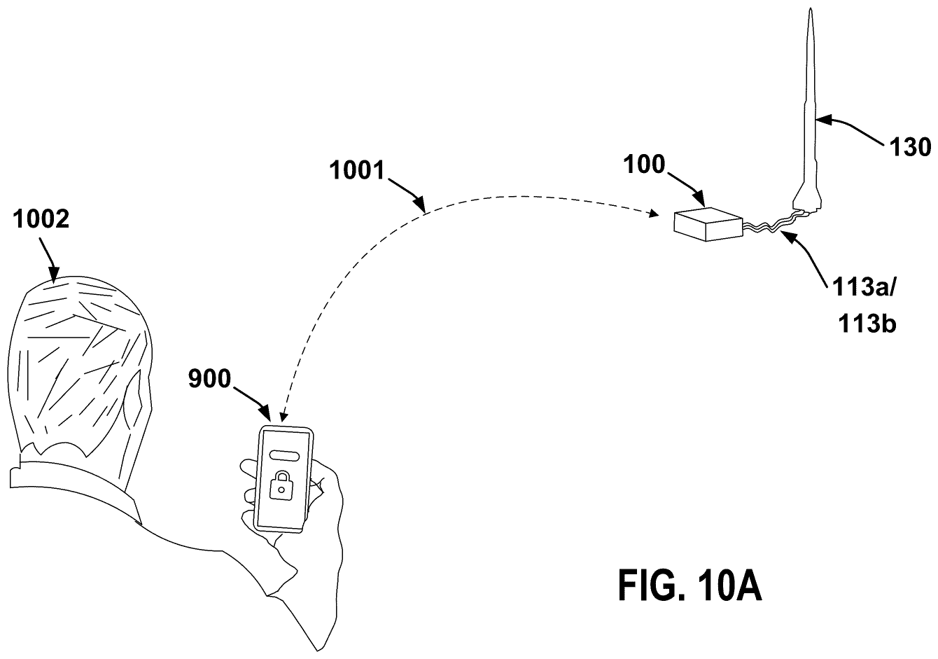

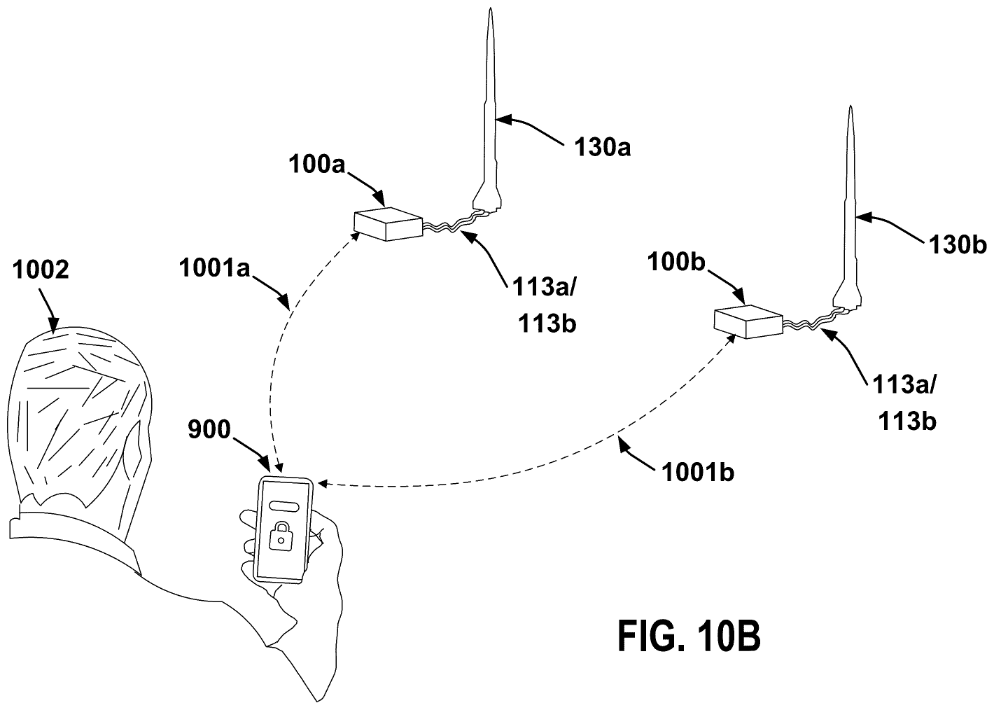

FIG. 9 contains exemplary components of a personal electronic device 900. A feature hereof may include an overall system including personal electronic device 900 and computing resources, whether on-board device 100/100a, or separate for example in personal or mobile hand-held computing devices, often referred to herein as personal electronic device(s). The overall system then providing the ability for a user 1002 as in FIGS. 10A and 10B, to control and provide input and directions for selecting, connecting, and controlling the functions of the system. In at least one implementation of the current developments, the personal electronic device is an iPhone® or iPad®, or other handheld device providing for wireless connectivity and ability to receive touch input from a user.

CPU/Processor(s) 902 can be any known processor, such as, but not limited to, an Intel® Core i9, Intel Core i7, Intel Core i5, Celeron®, Pentium® or Xeon® or AMD Ryzen Threadripper®, AMD Ryzen 9®, AMD Ryzen 7®, AMD Ryzen 5®, AMD Ryzen 3®, Apple A12 Bionic®, Apple MI®, or Motorola® lines of processors.

Memory 904 can be Random Access Memory (RAM), or any other dynamic storage device(s) commonly known in the art. Read only memory can be any static storage device(s) such as Programmable Read Only Memory (PROM) chips for storing static information such as instructions for processor 902.

Mass storage 907 can be used to store information and instructions. For example, hard disks such as the Adaptec® family of SCSI drives, an optical disc, an array of disks such as RAID, such as the Adaptec family of RAID drives, or any other mass storage devices may be used.

System bus 901 communicatively couples processor(s) 902 with the other memory, storage and communication blocks. System bus 901 can be a PCI/PCI-X or SCSI based system bus depending on the storage devices used.

Some detailed option for communication may include the following. In FIGS. 10A and 10B, a controller 100/100a is connected to a personal electronic device 900 via an wireless electronic connection, or wireless transmission path 1001, in many instances this is Bluetooth® or Bluetooth® Low Energy or BLE. In other instances, a wireless path could be via a WiFi system, for example, the personal electronic device may be capable of creating a personal hotspot, establishing a connection with a WiFi enabled controller, and communicating with the WiFi enable controller via an alternative wireless communication protocol. This would depend on the hardware possessed by the controller, and thus Bluetooth® may be a more desirable choice. The bi-directional arrow of transmission path 1001 indicates that there is communication both directions, that is from the personal electronic device 900 to the controller 100/100a, and from the controller 100/100a back to the personal electronic device 900. Information communicated between the personal electronic device may be information, instructions, and commands to progress the methodologies disclosed and described in FIGS. 7 and 8, or to provide the status of certain components of the controller 100/100a such as the: (1) over-current protection detection, (2) continuity detection, and/or (3) minimum voltage detection and the associated circuitry and sensors described in more detail in relation to FIG. 1. Moreover, the wireless communication link may be used to transmit data related to the battery status or other more advanced information that may be displayed on the personal electronic device. Also, shown in FIGS. 10A and 10B are the ignition leads 113a/113b which are connected to starter leads that are used to provide ignition of the motor and launch of a rocket 130. The user 1002 may provide inputs via the personal electronic device 900 via a touch screen that allows the user to control the user interface of the app.

FIG. 10B provides an alternative setup and communication of the personal electronic device 900 to two controllers 100a, 100b. The user 1002 is able to pair with multiple controllers simultaneously and thus launch multiple rockets at the same time from the one personal electronic device. The wireless transmission paths 1001a, 1001b provide discrete wireless communication signals, for example, between a first controller 100a and the personal electronic device 900, and between a second controller 100b and the personal electronic device 900. In this way, a user may control and synchronize the launch of two of more rockets 130a, 130b at the same time. Alternatively, the personal electronic device may have the capability of communicating with multiple controllers and launching multiple rockets simultaneously or sequentially.

Some of the implementations of the present developments include various steps. A variety of these steps may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIGS. 6A and 6B are examples of computing resources or computer systems with which implementations hereof may be utilized.

The components described above are meant to exemplify some types of possibilities. In no way should the aforementioned examples limit the scope of the developments hereof, as they are only exemplary embodiments.

Embodiments of the present developments relate to devices, systems, methods, media, and arrangements for providing communications and signals to control ignition output for a launch system. While detailed descriptions of one or more embodiments have been given above, various alternatives, modifications, and equivalents will be apparent to those skilled in the art without varying from the spirit of the developments hereof. Therefore, the above description should not be taken as limiting the scope of the inventions, which is defined by the appended claims.

1. (canceled)

2. A system for providing signals and controlling ignition output for a launch controller comprising:
an electronic controller comprising:
a power source providing power to a printed circuit board and circuitry;
the printed circuit board having an ignition output, a programming interface, and wireless module, the printed circuit board providing electrical connection between the ignition output, programming interface, and wireless module;
a personal electronic device capable of establishing a wireless connection between the personal electronic device and the electronic controller for sending signals to and receiving signals from the electronic controller.

3. A system of claim 2, the electronic controller having one or more of:
an RBG LED,
a reset button,
a power switch,
an arm/disarm switch
a multi-purpose button, and
a buzzer.

4. A system of claim 2, the electronic controller being wirelessly connected to the personal electronic device via a Bluetooth® connection or WiFi or other wireless connection.

5. A system of claim 2, the electronic controller capable of connecting to the personal electronic device and maintaining a connection while the electronic controller one of the following states:
idle state;
countdown state; and
ignition state.

6. A system of claim 2, the electronic controller further comprising, at least one of:
an over-current protection circuit,
a continuity detection circuit, and
a minimum voltage circuit.

7. A system of claim 2, the electronic controller being powered by one of:
alkaline or lithium AA batteries;
alkaline or lithium 9V batteries;
a rechargeable battery pack providing between 4V and 15V.

8. A system of claim 2, the electronic controller having a top side and a bottom side, the top side having the electrical components and circuitry, the bottom side having a battery holder mounted to it.

9. A system of claim 8, the electronic controller and battery holder being enclosed in a case, enclosure, or housing.

10. A system of claim 2, the electronic controller further having ignition leads.

11. A system of claim 2, the personal electronic device having a touch screen and user interface for providing input to send signals to and receive signals from the electronic controller.

12. (canceled)

13. (canceled)

14. (canceled)

15. (canceled)

16. (canceled)

17. (canceled)

18. (canceled)

19. An electronic wirelessly configurable and connectable launch controller device for providing ignition output comprising:
a power source providing power to a printed circuit board and circuitry;
the printed circuit board having an ignition output, a programming interface, and wireless module, the printed circuit board providing electrical connection between the ignition output, programming interface, and wireless module; and
one or more of:
an RBG LED,
a reset button,
a power switch,
an arm/disarm switch;
a multi-purpose button, and
a buzzer.

20. A device of claim 19, the electronic controller being capable of wirelessly connecting to a personal electronic device via one or more of a Bluetooth® connection or WiFi or other wireless connection.

21. A device of claim 19, the device being operable and capable of communication in one or more of the following states:
idle state;
countdown state;
ignition state; and
short-circuit state.

22. A device of claim 19, the device further comprising, at least one of:
an over-current protection circuit,
a continuity detection circuit, and/or
a minimum voltage circuit.

23. A device of claim 19, the power source comprising one of:
alkaline or lithium AA batteries;
alkaline or lithium 9V batteries;
a rechargeable battery pack providing between 4V and 15V.

24. A device of claim 19, the device having a top side and a bottom side, the top side having the electrical components and circuitry, the bottom side having a battery holder mounted to it.

25. A device of claim 24, the device and battery holder being mounted in and protected by a case, enclosure, or housing.

26. A device of claim 19, the device further having ignition leads capable of connecting to starter leads.

27. A device of claim 19, the device being configured to receive and send signals to a personal electronic device.

28. A system for providing signals and controlling ignition output for one or more launch controllers comprising:
one or more electronic controllers, each electronic controller comprising:
a power source providing power to a printed circuit board and circuitry;
the printed circuit board having an ignition output, a programming interface, and a wireless module, the printed circuit board providing electrical connection between the ignition output, programming interface, and wireless module;
a personal electronic device capable of establishing a wireless connection between the personal electronic device and the one or more electronic controllers for sending signals to and receiving signals from the one or more electronic controllers.

29. (canceled)

30. (canceled)

31. (canceled)
